(19) United States
(12) Patent Application Publication
(10) Pub. No.: US 2011/0299800 A1
(43) Pub. Date: Dec. 8, 2011

(54) Method for the Production of a Bearing Arrangement, and Bearing Arrangement

(76) Inventors: Stefanie Seufert, Massbach (DE); Helmut Hauck, Euerbach (DE); Alexander Dilje, Schweinfurt (DE); Hans-Jürgen Friedrich, Konigsberg (DE); Berthold Beyfuss, Kaisten (DE); Alfred Radina, Poppenlauer (DE); Jonas Schierling, Hassfurt (DE)

(21) Appl. No.: 13/132,563

(22) PCT Filed: Nov. 20, 2009
(86) PCT No.: PCT/EP2009/008266

§ 371 Date: Aug. 17, 2011

(30) Foreign Application Priority Data
Dec. 3, 2008 (DE) 10 2008 060 116.0

(51) Int. Cl. F16C 35/067; B23K 1/00

(52) U.S. Cl. 384/50; 384/548; 228/245

(57) ABSTRACT

A bearing assembly comprises at least one bearing element abutting against at least one adjacent part at a contact surface. The bearing assembly can be manufactured by disposing a reactive nano-crystalline layer between the bearing element and the adjacent part in the area of the contact surface and then initiating an exothermic reaction in the reactive nano-crystalline layer, so that the bearing element bonds to the adjacent part in a materially-connected manner. The exothermic reaction involves at least partially heating the surface area of the bearing element and/or of the adjacent part that is located in the area of the contact surface.

The invention relates to a method for manufacturing a bearing assembly comprising at least one bearing element and at least one adjacent part, wherein the bearing element and the adjacent part abut each other at a contact surface during operationally-intended usage. Furthermore, the invention relates to a bearing assembly.

In a wide variety of mechanical engineering applications, it is necessary to connect a bearing element (e.g., the bearing outer ring of a roller bearing) with an adjacent part (e.g., a bearing support). In such cases, a firm and stable connection is usually desired. Materially-bonded connections are particularly suitable for this purpose, in particular solder and weld connections.

If welding is utilized as the materially-bonded connecting process, modifications must be made, e.g., when the bearing element is a bearing ring. This is comprised mostly of through-hardened roller bearing steel, in particular the steel material 100Cr6, which is practically unweldable due to its high carbon content.

If such a bearing ring should be connected with an adjacent part in a materially-bonded manner, then soldering may be considered instead of welding. Soldering has an advantage that even unweldable materials can be connected with each other.

Soldering has a disadvantage that the mating parts must be heated to the required soldering temperature in the area of the mating surfaces, which can lead to damage in the bearing assembly due to the high heat input. Moreover, heating the to-be-mated parts is energy-intensive and leads to a large temperature variation in the components. Due to this temperature variation, deformation and even destruction of the connecting parts can result. Furthermore, an external energy source (e.g., a soldering torch) is required, which makes it a time-consuming process and not suitable for mass production.

Therefore, the object underlying the invention is to suggest a method of the above-mentioned type as well as a corresponding bearing assembly, with which method and/or bearing assembly the above-mentioned disadvantages can be avoided. A cost-effective possibility should thus be created, with which a bearing element and an adjacent part are connected in a materially-bonded manner even if the material of at least one of the parts to be connected together is made of an unweldable material. Moreover, no heat or, in any case at least only a minor amount of heat, should be experienced in the components due the materially-bonding connecting process, so that it results in no damage in the bearing element and/or the adjacent part.

The solution of this object, with respect to the method, is characterized by the invention in that the steps are provided:
a) Disposing the bearing element and the adjacent part in the operationally-intended position relative to each other and placing a reactive nano-crystalline layer between the bearing element and the adjacent part in the area of the contact surface;
b) Initiating an exothermic reaction in the reactive nano-crystalline layer, so that the bearing element and the adjacent part are connected in a materially-bonded manner by at least partial heating of the surface area of the bearing element and/or of the adjacent part, which surface area is located in the area of the contact surface.

Therefore, the nano-crystalline layer serves as a “fuel” for producing the materially-bonded connection; it heats the joined parts, whereby a mating like a solder or weld connection, in particular, can be produced.

The initiation of the exothermic reaction in the reactive nano-crystalline layer according to step b) can also lead to a materially-bonded connection between the nano-crystalline layer and the bearing element and/or the adjacent part by at least partially melting the surface area of the bearing element and/or the adjacent part, which surface area is located in the area of the contact surface.

The placing of the reactive nano-crystalline layer between the bearing element and the adjacent part according to step a) can take place during or after the bearing element and the adjacent part are or have been disposed in the operationally-intended relative position. Alternatively, it is also possible that the placing of the reactive nano-crystalline layer between the bearing element and the adjacent part according to step a) takes place before the bearing element and the adjacent part are disposed in the operationally-intended relative position.

In the latter case, a specific possibility exists that the reactive nano-crystalline layer is applied to the bearing element and/or the adjacent part in the area of the contact surface.

Before performing step a), a layer of solder can be placed, at least in sections, in the area of the contact surface between the bearing element and the reactive nano-crystalline layer and/or between the adjacent part and the reactive nano-crystalline layer. Alternatively, before performing the above-mentioned step, it is also possible that the bearing element and/or the adjacent part is/are provided with a coating in the area of the contact surface, wherein the coating is solder or includes solder.

According to a preferred embodiment of the proposed method, the initiation of the exothermic reaction in the reactive nano-crystalline layer according to step b) can take place by conducting an electric current through the reactive nano-crystalline layer.

During the exothermic reaction in the reactive nano-crystalline layer according to step b), the bearing element and the adjacent part can be pressed relative to and against each other. This assists the formation of a fixed connection between the to-be-mated components.

The proposed bearing assembly comprises at least one bearing element and at least one adjacent part, wherein the bearing element and the adjacent part abut each other at a contact surface during operationally-intended usage. According to the invention, it is provided that a reactive nano-crystalline layer is disposed in the area of the contact surface, wherein the reactive nano-crystalline layer forms a materially-bonded connection between the bearing element and the adjacent part by undergoing an exothermic reaction.

The reactive nano-crystalline layer can be inserted as a separate structure between the bearing element and the adjacent part. However, it is also possible that the reactive nano-crystalline layer is applied to the bearing element and/or the adjacent part as a coating.

Further, a layer of solder can be disposed between the reactive nano-crystalline layer and the bearing element and/or between the reactive nano-crystalline layer and the adjacent part. However, it is also possible to form the reactive nano-crystalline layer together with the solder as a separate element, which can be applied according to the above-mentioned step a).

According to a preferred embodiment of the invention, the bearing element is a component of a roller bearing and has at least one track for roller bodies. However, it is also possible that the bearing element is a component of a slide bearing and has at least one slide surface.

The adjacent part can be embodied as a bearing support. The bearing support can have at least one circular recess for receiving the bearing ring of a roller bearing, wherein the reactive nano-crystalline layer is disposed around the circumference of the circular recess. The adjacent part is comprised of a metal sheet, particularly in the latter case.

The bearing element is mostly comprised of steel, in particular roller bearing steel, particularly preferably 100Cr6, in order to inventively avoid in a simple manner the disadvantage that the above-mentioned material is unweldable. However, the bearing element can also be comprised of a non-metallic material, in particular a ceramic material, which is typical for some slide bearings.

The inventive concept is therefore based on providing a process for the mating of a bearing element and an adjacent part, which process is based upon the use of exothermally-reactive layers or particles. These layers are based, e.g., on the use of nickel (Ni) and aluminum (Al).

For details relating to the reactive nano-crystalline layer, express reference is made to U.S. Pat. No. 6,991,856, where the reactive nano-crystalline layers provided for the use are described and disclosed in detail. The provided reactive nano-crystalline layers are preferably foils, which have a plurality of thin layers that can act as a local heat source. Such layers are commercially available under the tradename NanoFoil® from the company, Reactive Nano Technologies Inc., USA. The above-mentioned layer represents a thermally unstable layer, which can be activated, for example, by the application of electrical energy.

The proposed mating process with the reactive nano-crystalline layers is also known by the term “cold joining” since the energy, which is required for the connection, is generated by the layer virtually by itself within a fraction of a second and in fact, precisely and exclusively in the mating area.

For example, the layers provided according to invention can be built up by depositing the above-mentioned reactive nano-crystalline foils. Alternatively, it is also possible to apply the layer of reactive nano-crystalline material directly onto at least one side of the to-be-mated contact surfaces (of the bearing element and/or adjacent part) by using well-known coating processes (e.g., by “Physical Powder Deposition”—abbreviated as DVP). Depending on the reachable temperature and the material to be connected during the thermal reaction, if necessary, a supplemental material in the form of a solder is advantageous and/or required.

The inventive proposal can be performed in an advantageous manner so that the materially-bonded connection, in relation to the entire component, can take place at nearly room temperature. Therefore, no thermal deformation of the to-be-mated components and no destruction and no damage thereof results. Further, no additional energy source for the heat input is required.

The proposed method is generally applicable to all types of bearing elements (e.g., also for slide bearings having ceramic material), in which supplemental components, e.g., flanges, should be fixed in a high-strength and cost-effective manner, or in which completed roller bearings (having heat-sensitive seals) must be directly connected with adjacent parts in a materially-bonded manner.

The reactive nano-crystalline layers are preferably utilized in the form of foils. However, it is also possible to apply these layers in the form of a paste-like material.

Exemplary embodiments of the invention are illustrated in the drawings.

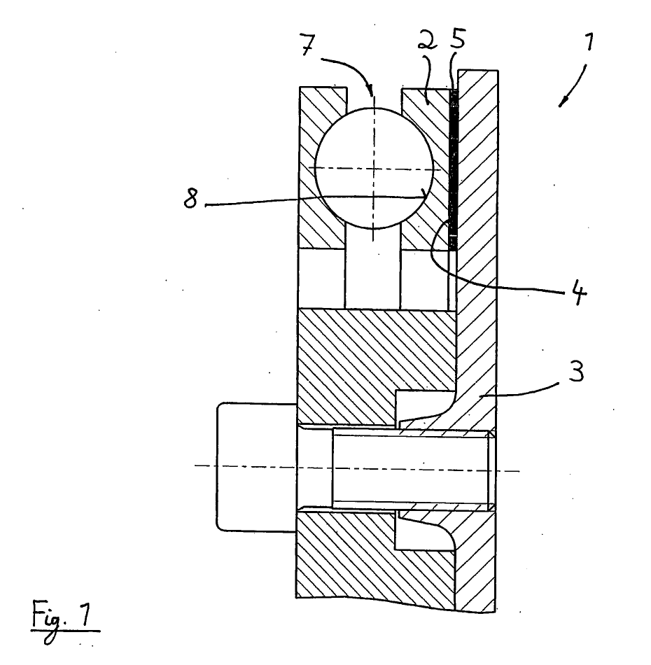

FIG. 1 schematically shows a cross-section through a bearing assembly, in which a roller bearing is utilized in the form of an axial roller bearing,

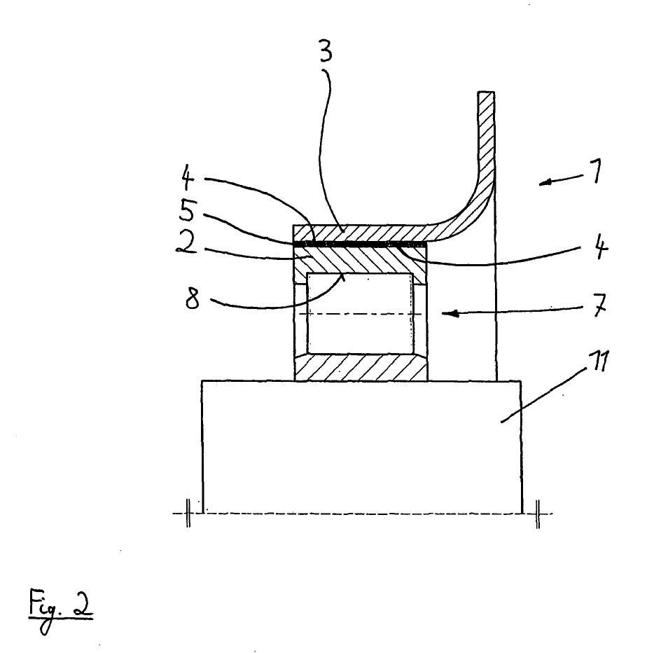

FIG. 2 schematically shows a cross-section through a bearing assembly, in which a roller bearing in the form of a cylindrical roller bearing supports a shaft relative to an adjacent part,

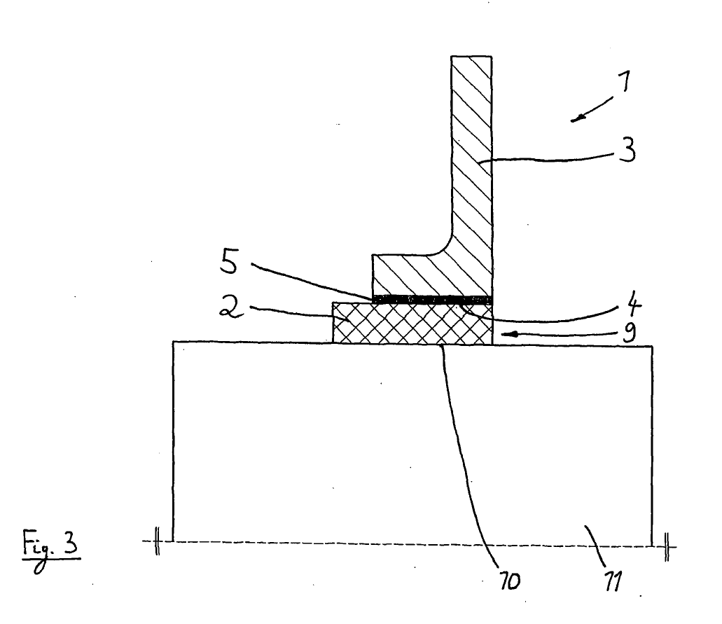

FIG. 3 schematically shows a cross-section of a bearing assembly, in which a slide bearing supports a shaft relative to an adjacent part, and

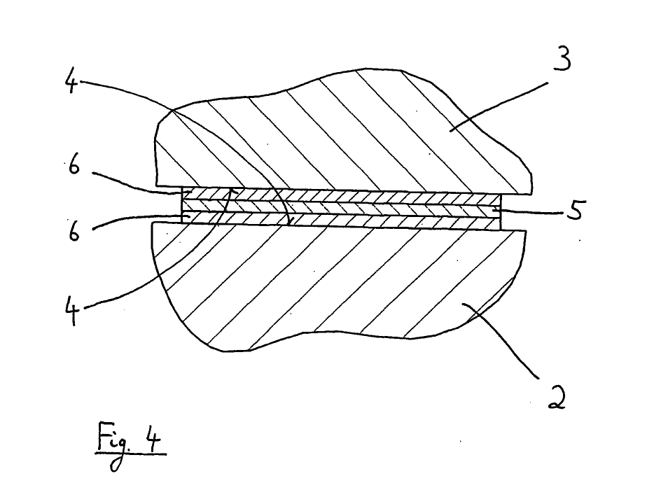

FIG. 4 shows an enlarged illustration of the materially-bonded connection between a bearing element and an adjacent part.

In FIG. 1, a bearing assembly 1 is illustrated that comprises a roller bearing 7 in the form of an axial roller bearing, which is disposed on an adjacent part 3 in the form of a bearing support. More precisely, one of the bearing rings, i.e. the bearing element 2, is connected with the adjacent part 3 in a materially-bonded manner. The bearing ring 2 has a track 8 for the balls of the bearing.

The bearing element 2 and the adjacent part 3 contact each other at a contact surface 4. A layer 5 made of reactive nano-crystalline material is inserted into the resulting contact gap. If this layer 5 is activated, e.g., by applying an electric current that flows through the layer 5, an exothermal process results, which leads to the fusion of the opposing surface areas of the bearing element 2 and the adjacent part 3 and, together with the fusion of the layer 5 itself, leads to a firm materially-bonded connection between the bearing element 2 and the adjacent part 3.

In FIG. 2, basically the same situation is illustrated, wherein a roller bearing 7 in the form of a cylindrical roller bearing supports a shaft 11 relative to an adjacent part 3.

As FIG. 3 shows, the inventive proposal can also be applied in the same manner when it concerns the fixing of a bearing element in the form of a slide bearing 9 to an adjacent part 3. Here, the bearing element 2 is comprised of a slide bushing made from ceramic material, which is to be fixed to the adjacent part 3. The slide bushing 2 has a slide surface 10, along which a shaft 11 is supported.

Again, a layer 5 made of reactive nano-crystalline material is utilized on the adjacent part 3 for the materially-bonded fixing of the bearing element 2.

According to FIG. 4, a layer 6 of solder can be also disposed between the reactive nano-crystalline layer 5 and the bearing element 2 and/or the adjacent part 3 before the layer 5 is activated and the materially-bonded connection is thereby produced.

### REFERENCE NUMBER LIST

1 bearing assembly
2 bearing element
3 adjacent part
4 contact surface
5 reactive nano-crystalline layer
6 layer of solder
7 roller bearing
8 track
9 slide bearing
10 slide surface
11 shaft

1.-20. (canceled)

21. A method for manufacturing a bearing assembly comprising at least one bearing element and at least one adjacent part, wherein the bearing element and the adjacent part abut each other at a contact surface during operationally-intended usage, the method comprising:
a) disposing the bearing element and the adjacent part together in the operationally-intended position relative to each other and placing a reactive nano-crystalline layer between the bearing element and the adjacent part in the area of the contact surface, and
b) initiating an exothermic reaction in the reactive nano-crystalline layer, so that the bearing element and the adjacent part are connected in a materially-bonded manner by at least partially heating the surface area of at least one of the bearing element and the adjacent part that is located in the area of the contact surface,
wherein the placing of the reactive nano-crystalline layer between the bearing element and the adjacent part according to step a) takes place before the bearing element and the adjacent part are disposed in the operationally-intended relative position,
the reactive nano-crystalline layer is applied to at least one of the bearing element and the adjacent part in the area of the contact surface, and
before performing step a), at least one of the bearing element and the adjacent part is provided with a coating in the area of the contact surface, wherein the coating is solder or includes solder, or before performing step a), a layer of solder or a solder-containing material is placed in the area of the contact surface between the reactive nano-crystalline layer and at least one of the bearing element and the adjacent part.

22. A method according to claim 21, wherein the initiating of the exothermic reaction in the reactive nano-crystalline layer comprises conducting an electric current through the reactive nano-crystalline layer.

23. A method according to claim 22, further comprising pressing the bearing element and the adjacent part against each other during the exothermic reaction in the reactive nano-crystalline layer.

24. A bearing assembly comprising:
at least one bearing element,
at least one adjacent part abutting against the bearing element at a contact surface,
a layer of solder disposed on at least one of the bearing element and the adjacent part in at least a portion of the contact surface, and
a reactive nano-crystalline layer applied as a coating to the layer of solder, wherein the reactive nano-crystalline layer is capable undergoing an exothermic reaction to melt the layer of solder to thereby form a soldered connection between the bearing element and the adjacent part.

25. A bearing assembly according to claim 24, wherein the bearing element is a component of a roller bearing and has at least one track for roller bodies.

26. A bearing assembly according to claim 24, wherein the bearing element is a component of a slide bearing and has at least one slide surface.

27. A bearing assembly according to claim 24, wherein the adjacent part is a bearing support.

28. A bearing assembly according to claim 27, wherein the bearing support has at least one circular recess configured to accommodate a bearing ring of a roller bearing, wherein the reactive nano-crystalline layer is disposed around the circumference of the circular recess.

29. A bearing assembly according to claim 24, wherein the adjacent part is comprised of sheet metal.

30. A bearing assembly according to claim 24, wherein the bearing element is comprised of roller bearing steel.

31. A bearing assembly according to claim 24, wherein the bearing element is comprised of 100Cr6.

32. A bearing assembly according to claim 24, wherein the bearing element is at least partially comprised of a non-metallic material.

33. A bearing assembly according to claim 32, wherein the bearing element is comprised of ceramic material.

34. A method for manufacturing a bearing assembly comprising a bearing element that fixedly abuts on an adjacent part at a contact surface, the method comprising:
disposing a layer of solder-containing material on at least one of the bearing element and the adjacent part so as to cover at least a portion of the contact surface,
disposing a layer of reactive nano-crystalline layer on the solder-containing material so as to cover at least a portion of the solder-containing material,
positioning the bearing element adjacent to the adjacent part, and
initiating an exothermic reaction in the reactive nano-crystalline layer to melt the solder-containing material, so that the bearing element becomes affixed to the adjacent part by a soldered connection over at least a portion of the contact surface.

35. A method according to claim 34, wherein initiating an exothermic reaction in the reactive nano-crystalline layer comprises conducting electric current through the reactive nano-crystalline layer.

36. A method according to claim 35, further comprising pressing the bearing element and the adjacent part against each other during the exothermic reaction.

37. A method according to claim 36, wherein the bearing element is comprised of roller bearing steel and the adjacent part is comprised of sheet metal.

38. A method according to claim 37, wherein:
a layer of solder is disposed on each of the bearing element and the adjacent part so as to cover at least a portion of the contact surface, and
the layer of reactive nano-crystalline layer is sandwiched between the two layers of solder.

39. A method according to claim 38, wherein the adjacent part is a bearing support having at least one circular recess configured to accommodate a bearing ring of a roller bearing, wherein the reactive nano-crystalline layer is disposed around the circumference of the circular recess.

40. A method according to claim 39, wherein reactive nano-crystalline layer comprises nickel and aluminum.
